(19) United States
(12) Patent Application Publication
(10) Pub. No.: US 2008/0059190 A1
(43) Pub. Date: Mar. 6, 2008

(54) Speech unit selection using HMM acoustic models

(75) Inventors: Min Chu, Beijing (CN); Peng Liu, Beijing (CN); Yong Zhao, Beijing (CN); Yusheng Li, Beijing (CN)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/508,093

(22) Filed: Aug. 22, 2006

(51) Int. Cl. G10L 13/00

(52) U.S. Cl. 704/258

(57) ABSTRACT

A concatenating speech synthesizer concatenates selected speech units to obtain the desired synthesized speech. When desired speech units of phonetic and/or prosodic context are not available, the synthesizer selects replacement speech units based on measures representative of the difference between the HMM acoustic models of the desired speech unit and available speech units.

### BACKGROUND

The discussion below is merely provided for general background information and is not intended to be used as an aid in determining the scope of the claimed subject matter.

Text-to-speech technology allows computerized systems to communicate with users through synthesized speech. One form of concatenative speech synthesizer is a unit-selection text-to-speech (TTS) system. The unit-selection TTS system includes a database of recorded speech segments. When an utterance is desired, the unit-selection TTS system selects individual speech segments to form the utterance.

Commonly, the units selected for an utterance are chosen by finding a sequence that minimizes a cost function, which is used to measure the distortion of the synthesized utterance. Accordingly, the output speech quality of the system relies heavily on the definition of the cost function.

However, defining a cost function that can ideally reflect the “unnaturalness” of synthesized speech in a manner that represents the subjective perspective of a human is not a trivial task. First, the factors or parameters considered crucial for speech quality, their representative functions as well as their interaction between each other are not well studied. In addition, even though cost functions exist and are used, evaluating whether a change in the cost calculation better represents human perception is difficult, since a change will potentially improve the speech quality with respect to some factor, but will hurt the speech quality with respect to another factor.

Various techniques have been proposed to optimize parameters in the cost function. Some systems have optimized weights in the cost function by minimizing an objective measure between the reference sentence and the synthesized utterance, while others have been based on a correlation between spectral distances and the perceptual discontinuities. In yet another system, a correlation is used between the cost function and MOS (mean opinion score). However, each of these systems uses, at some level, perceptual evaluations by humans, which are difficult to collect. As a consequence, the parameters to be optimized are generally constrained with numbers, or particular phone contexts. Also, the optimization algorithms used can be difficult to apply to new speech corpora, or languages.

### SUMMARY

The Summary and Abstract are provided to introduce a selection of concepts in a simplified form that are further described below in the Detailed Description. The Summary and Abstract are not intended to identify key features or essential features of the claimed subject matter, nor are they intended to be used as an aid in determining the scope of the claimed subject matter. In addition, the claimed subject matter is not limited to implementations that solve any or all disadvantages noted in the background.

In the foregoing systems discussed above, each of these systems uses, at some level, perceptual evaluations by humans, which are difficult to collect. As a consequence, the parameters to be optimized are generally constrained with numbers, or particular phone contexts. Also, the optimization algorithms used can be difficult to apply to new speech corpora, or languages.

A concatenating speech synthesizer described herein concatenates selected speech units to obtain the desired synthesized speech. When desired speech units of phonetic and/or prosodic context are not available, the synthesizer selects replacement speech units based on measures representative of the difference between the HMM (Hidden Markov Models) acoustic models of the desired speech unit and available speech units.

In one embodiment, a form of Kullback-Leibler Divergence (KLD) is used to calculate the mismatch cost between the speech units. Since the measures are based on HMM acoustic models, the proposed method has the advantage of being applied to new corpora or languages without the need to collect perceptual data.

### BRIEF DESCRIPTION OF THE DRAWINGS

FIG. 1 is a block diagram of a speech synthesizer.

FIG. 2 is a flowchart of a method for calculating mismatch between HMM models of different context.

FIG. 3 is a schematic diagram illustrating mismatch between HMM models.

FIG. 4 is a flowchart of a method for obtaining phonetic measures between HMM acoustic models.

FIG. 5 is a flowchart of a method for obtaining prosodic measures between HMM acoustic models.

FIG. 6 is a flowchart of a method for generating synthesized speech.

FIG. 6A is flowchart for selecting speech units for synthesized speech.

FIG. 7 is a flowchart of a method for calculating KLD.

FIG. 8 is a schematic diagram of state duplication (copy) with a penalty.

FIG. 9 is a schematic diagram illustrating possible operations to add a state to an HMM.

FIG. 10 is a schematic diagram illustrating modifying two HMMs based on a set of operations and calculating KLD.

FIG. 11 is a flowchart for the diagram of FIG. 10.

FIG. 12 is one illustrative example of state matching of two HMMs.

FIG. 13 is an exemplary computing environment.

FIG. 14 is a second illustrative example of state matching of two HMMs.

### DETAILED DESCRIPTION

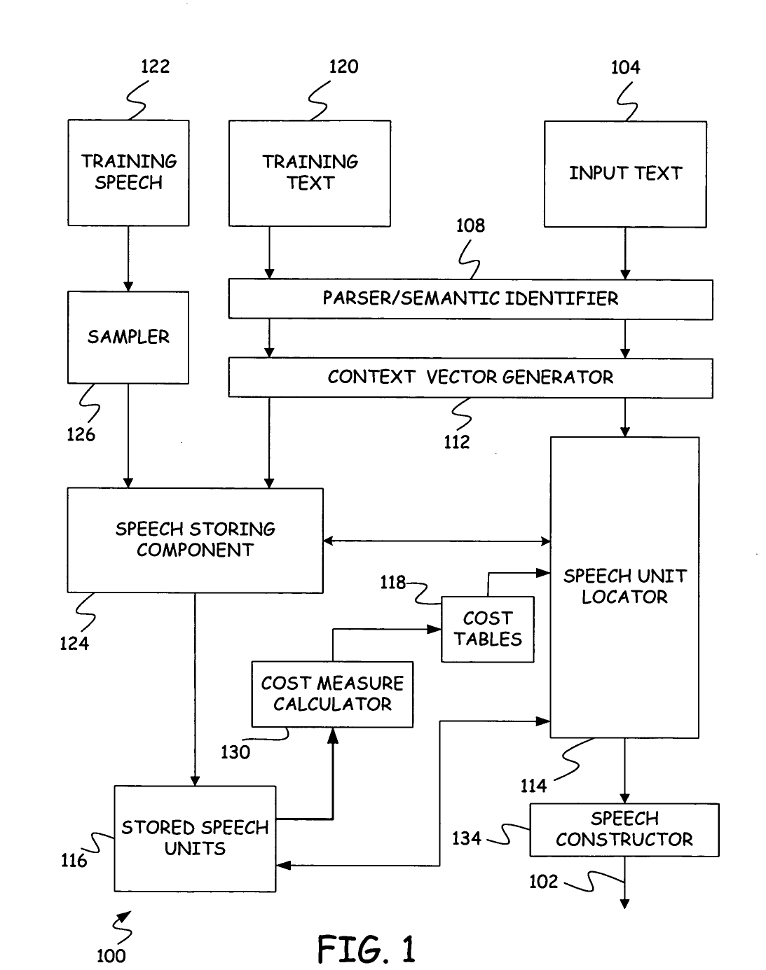

FIG. 1 illustrates a unit-selection, concatenative speech synthesizer 100 that generates synthesized speech 102 from input text 104. Generally, speech synthesizer 100 includes a parser/semantic identifier 108 that parses input text 104 and identifies phonetic and prosodic information for each speech unit produced by the parser/semantic identifier 108. The phonetic and prosodic information is then provided to context vector generator 112, which generates a context vector for each speech unit identified by the parser/semantic identifier 108. The context vectors are provided to a speech unit locator 114, which uses the vectors to identify a set of speech units for the sentence. In particular, the speech unit locator 114 selects speech units from stored speech units 116 based on context-dependent HMM models that have been previously trained to represent units in different phonetic and/or prosodic contexts. A measure between the target or desired speech unit model in the phonetic and prosodic context and available speech unit models 116 is used to select the speech unit to be used in speech synthesis. In other words, the mismatch cost between the target speech unit and a candidate speech unit that is available in the stored speech units 116 is calculated using the measures between the HMM acoustic models that statistically represent these units. An advantage of this method is that it can be applied to new corpora or languages without the need of collecting perceptual data that is needed for optimizing the corresponding cost function used by other methods.

In one embodiment, rather than calculating each measure during the selection process, measures can be pre-calculated and stored in cost tables 118. In particular, a cost table can be calculated for each phonetic and prosodic feature component.

Before speech synthesizer 100 can be utilized to construct speech 102, it must be initialized with samples of speech units taken from a training text 120 that is audibly read to provide training speech 122. The manner in which training text 120 and training speech 122 are obtained is not pertinent to this description. However, in one embodiment, the training text 120 can be obtained from a large corpus of text using the techniques described in U.S. Pat. No. 6,978,239.

Storing speech units 116 begins by parsing the sentences of text 120 into individual speech units that are annotated with high-level phonetic and prosodic information. In FIG. 1, this is accomplished by the parser/semantic identifier 108. The parsed speech units and their high-level phonetic and prosodic description are then provided to the context vector generator 112. The context vector generator 112 generates a Speech unit—Dependent Descriptive Contextual Variation Vector (SDDCVV, referred to herein as a “context vector”). The context vector describes several context features that can affect the prosody of the speech unit. Under one embodiment, the context vector describes features or coordinates such as but not limited to:

Prosodic context:
Position in phrase (PinP)—the position of the current speech unit in its carrying prosodic phrase;
Position in word (PinW)—the position of the current speech unit in its carrying prosodic word;
Position in syllable (PinS)—the position of the current speech unit in its carrying prosodic syllable;
Accent Level in Word (AinW)—the level of emphasis of the speech unit in the word; and
Emphasis Level in Phrase (EinP)—the level of emphasis of the word in the phrase; and

Phonetic context:
Left phonetic context (LPhC)—category of the last phoneme in the speech unit to the left (preceding) of the current speech unit; and
Right phonetic context (RPhC)—category of the first phoneme in the speech unit to the right (succeeding) of the current speech unit.

It should be noted other units of a language besides a “word” and “phrase” as described above can be used, if desired.

The context vectors produced by context vector generator 112 are provided to a speech storing component 124 along with speech samples produced by a sampler 126 from training speech signal 122. Each sample provided by sampler 126 corresponds to a speech unit identified by parser 108. Speech storing component 124 indexes each speech sample by its context vector to form an indexed set of stored speech units 116.

As indicated above one aspect described herein is selecting speech units from stored speech units 116 based on context-dependent HMM models that have been previously trained to represent units in different phonetic and prosodic contexts. In particular, the synthesizer 100 uses a cost function to aid in the selection of speech units for speech synthesis. The cost function is typically defined as a weighted sum of the target cost and the concatenation cost. The target cost is the sum of measures in phonetic constraints and/or prosodic constraints and will be discussed further below. The concatenation cost can take any appropriate values, indicators, or labels, such as binary values, 0 when the two segments to be concatenated are succeeding segments in the recorded speech and 1 otherwise.

The target cost takes into account the compatibility between the candidate speech unit and the target speech unit. Let t=[t₁,t₂, . . . ,t_{J}] and u=[u₁,u₂, . . . ,u_{J}] denote the corresponding target and candidate context vectors, respectively. Generally, target cost is defined as:

$${C}^{t} ( t , u ) = {\sum }_{j = 1}^{J} {w}_{j}^{t} {C}_{j}^{t} ( {t}_{j} , {u}_{j} ) \qquad ( 1 )$$

where Cⱼ^{t},j=1,2, . . . J, is the sub-cost for the j^{th} feature, and is weighted by wⱼ^{t}.

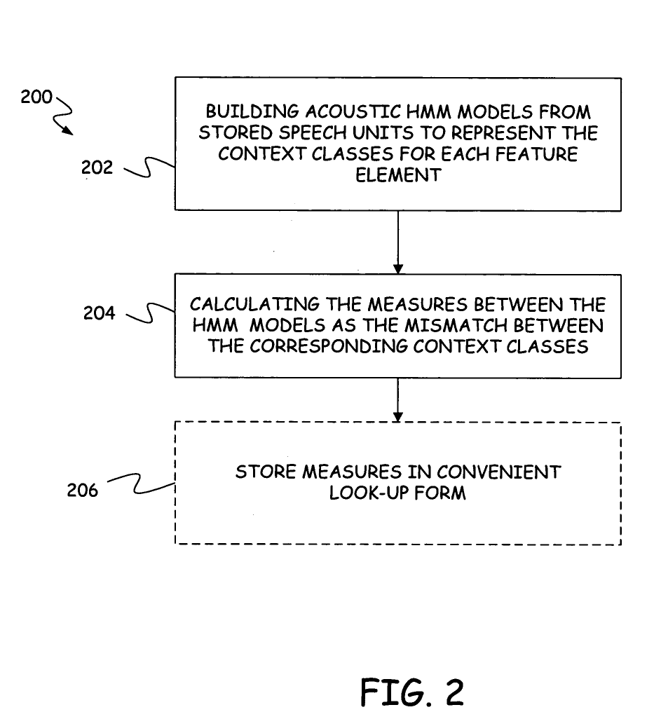

The sub-costs for the categorical features can be automatically estimated by acoustically modeling on the context classes of the feature. Referring to FIG. 2, this method, indicated by reference numeral 200, involves building acoustic HMM models from the stored speech units 116 to represent the context classes for each feature element at step 202; then the measures between the HMM acoustic models are calculated as the mismatch between the corresponding context classes at step 204.

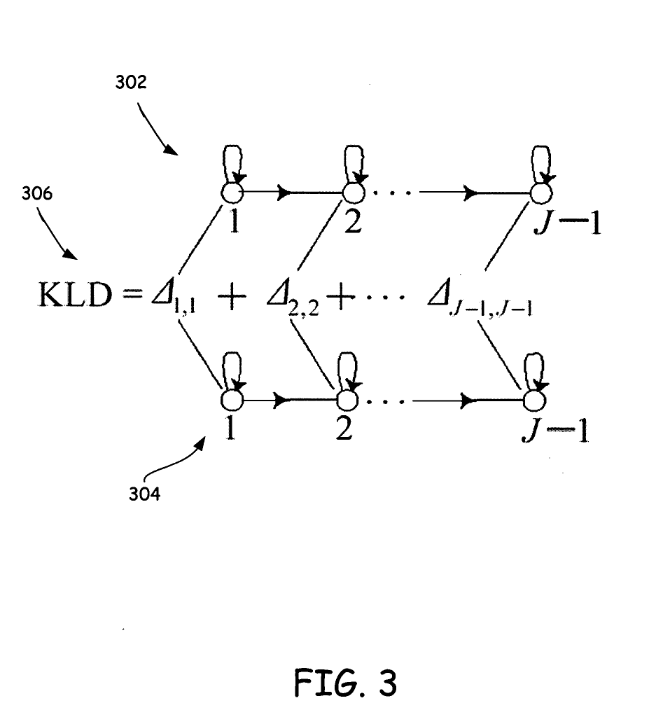

There are many ways to define the measure between context dependent HMM acoustic models. In one embodiment, Kullback-Leibler Divergence (KLD) is used to measure the dissimilarity between two HMM acoustic models. In terms of KLD, the target cost can be represented as:

$${C}^{t} ( t , u ) = {\sum }_{j = 1}^{J} {w}_{j}^{t} D ( {T}_{j} ∥ {U}_{j} ) \qquad ( 2 )$$

where Tⱼ and Uⱼ denote the target and candidate models corresponding to unit feature tⱼ and uⱼ, respectively. For purposes of explanation, the target cost can be defined based on phonetic and prosodic features (i.e. a phonetic target sub-cost and a prosodic target sub-cost). A schematic diagram of measuring the target cost for a first HMM tᵢ 302 and a second HMM uⱼ 304 with KLD 306 is illustrated in FIG. 3.

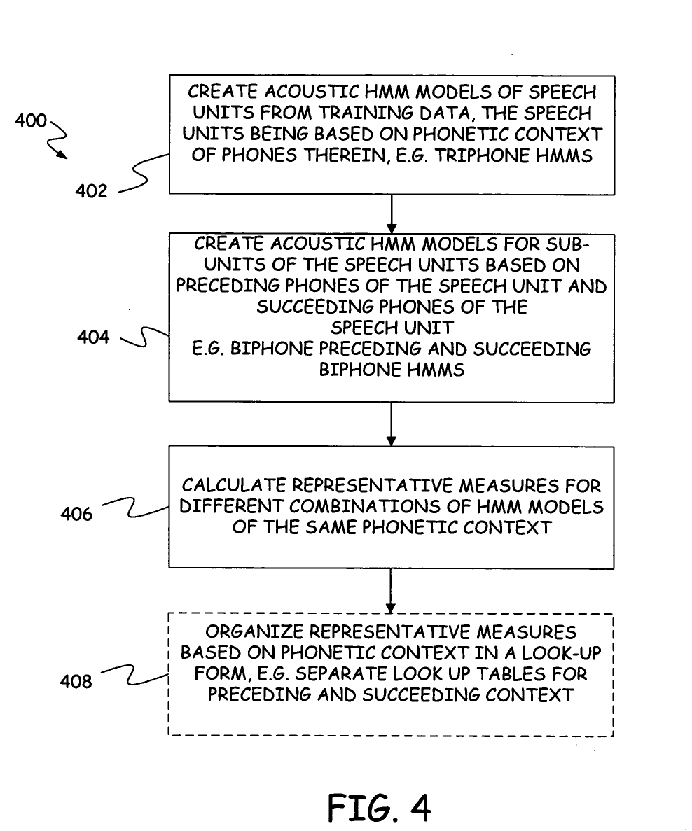

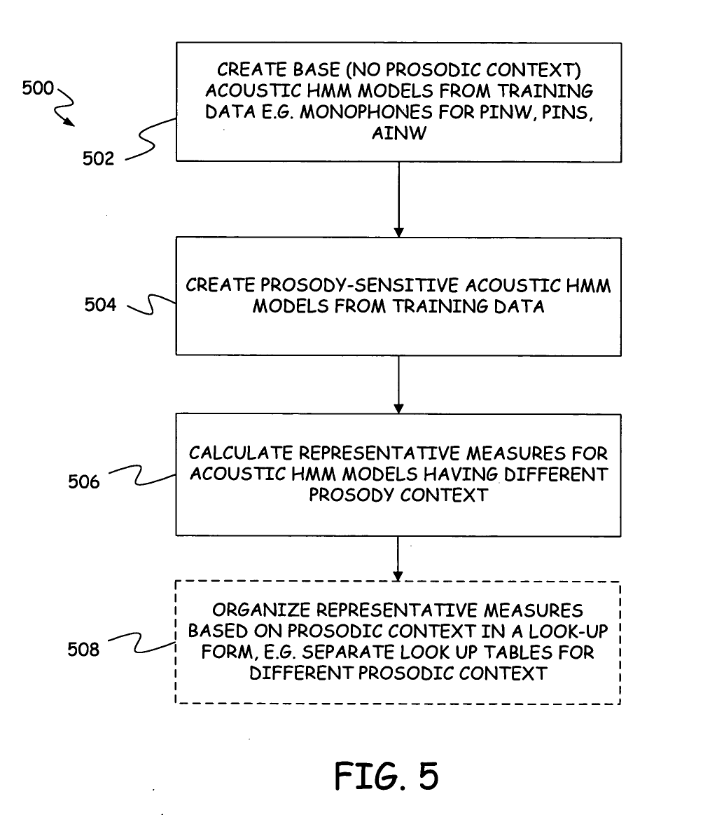

A significant problem in target cost estimation is how to build reliable context-feature HMMs, which characterize the addressed context classes, while removing the influences of other features. In the discussion provided below, exemplary methods are provided to build appropriate HMM models for both phonetic and prosodic features and obtain corresponding measures between different combinations. Methods 400 and/or 500 illustrated in FIGS. 4 and 5 respectively, are example cost estimations which can be used in step 204 of FIG. 2.

Using by way of example the features described above, the phonetic target sub-cost comprises sub-costs for the Left Phone Context (LPhC) and the Right Phone Context (RPhC). For example, when selecting a speech unit /aw/ for the target phone sequence /m aw/, a speech unit /aw/ following a /m/ is desired; yet assume only /aw/'s following other speech units are available. Hence a measurement that can rank similarity of LPhC of the available /aw/'s is needed.

FIG. 4 illustrates method 400 for obtaining phonetic sub-costs or measures. At step 402, acoustic models are created of speech units from the training data 124. The speech units are based on the phonetic context of the phones therein, for example, triphone HMMs can be used.

At step 404, acoustic models for sub-units of the speech units are created based on preceding phones of the speech unit and succeeding phones of the speech unit. Although various phone models can be used, in one embodiment by way of example, biphone model is used to represent the LPhC and RPhC. As indicated above, the models can be estimated from the regular tri-phone HMMs. Using by way of example LPhC, let l−c+r denote a triphone model, where l, c, and r are the left phone, center phone, and right phone, respectively. When the focus is on the LPhC of c, all triphone models with center phone c, the specified left phone l and whatever right phone are extracted and merged into a left biphone model l-c for c. The left biphone models are then substantially independent from its right context, i.e. the states on the right half of the model should have little discriminating information about the right phone context and the states on the left half of the model preserve the discrimination between left phones.

At step 406, representative measures are calculated for different combinations of sub-units of the same phonetic context. As discussed above, the measure can be the KLD, a novel algorithm of which is discussed below. At step 406, the measure can be normalized, for instance, the KLD measure can be normalized with a logarithm function, or sigmoid function, into a fixed range such as 0 to 1 so that the weight of the sub cost for each feature can somewhat keep unchanged.

At step 408, the representative measures can be organized based on phonetic context in a convenient form such as in a look-up form, thereby forming some of the cost tables 118 of FIG. 1 (the general form of which is indicated in FIG. 2 at 206). With respect to FIG. 1, a cost measure calculator 130 accesses the indexed stored speech units 116 to perform method 400 and store corresponding cost tables 118.

It should be pointed out that the representative measures obtained with the proposed method are unit dependent, i.e. if 40 phones are defined for English, 40 cost tables will be created for each of the phonetic context vector feature element LPhC and RPhC.

The prosodic target costs comprise the sub-costs, for example, Position in Phrase (PinP), Position in Word (PinW), Position in Syllable (PinS), Accent Level in Word (AinW) and Emphasis Level of the word in Phrase (EinP). FIG. 5 illustrates an example method 500 for obtaining prosodic sub-costs or measures. In general, method 500 includes building separate sets of prosody-sensitive monophone HMMs to represent different prosodic categories, where representative measures are again calculated. At step 502, acoustic HMM models for mono-phones (no prosodic context) are created from the training data for each speech unit.

At step 504, prosody-sensitive HMM acoustic models are obtained from the training data. In particular, after the base monophone HMMs are trained at step 502, then the base phone models are split into an appropriate number of prosody sensitive HMMs for the particular prosodic context feature, i.e. the phone set is expanded by integrating with the categorical labels for the prosodic context feature, which may take the form of c:x, where x is phone c's categorical label for a given prosodic context feature. Using by way of example PinW, it may have 4 categorical values or labels: at Onset, Nucleus, Coda of a word or a Mono syllable word. To model PinW context, base monophone HMMs are first trained, then the base phone models are split into 4 PinW sensitive HMMs, i.e. the phone set is expanded by integrating with PinW, taking the form of c:x, where x is phone c's PinW label. For example, the word ‘robot’ with pronunciation /r ow-b ax t/ is composed of two syllables, where the first syllable is with PinW Onset, and the second with Coda, thus the phones are expanded with the form as /r:o ow:o-b:c ax:c t:c/, where o stands for Onset, c for coda.

In a manner similar to step 406, step 506 representative measures for acoustic models having different prosody context are calculated for each speech unit. Again, in one embodiment, this calculation can comprise calculating the KLD of the different prosody contexts in the manner discussed below, where the calculated measure can be normalized. For instance, the normalized KLD between HMM models c:x₁ and c:x₂ represents the measure between PinW x₁ and x₂ for speech unit c. All the prosodic target sub-costs can be calculated in this manner by creating the mono-phone models extended with corresponding prosodic labels. However, it should be noted, with respect to PinS, vowels and consonants generally take on two category values each. Vowels generally are either nucleus or mono, while consonants are either onset or coda. With respect to Accent in Word, this may be based only on whether a vowel is accented or not, although if desired Accent in Word can be extended to consonants. Emphasis in Phrase is based on whether the word is emphasized or not within the phrase.

At step 508, like step 408, the. representative measures can be organized based on prosodic context in a convenient form such as in a look-up form, thereby forming some of the cost tables 118 of FIG. 1. Like the representative measures for phonetic context, the representative measures for prosodic context are unit dependent.

As indicated above, speech unit dependent cost tables for each of the context vector features can be generated. This is in contrast to prior art cost tables that are typically shared by all speech units. Speech unit dependent cost tables can improve naturalness in view of the inherent differences in the audible sound of the speech units particularly when rendered in different contexts. However, in a further embodiment, some cost tables can be shared by a plurality of speech units, if desired. Grouping of speech units to share one or more cost tables, can be performed in several ways including manually grouping according to phonetic knowledge, and/or automatic grouping based on the similarity of the cost tables.

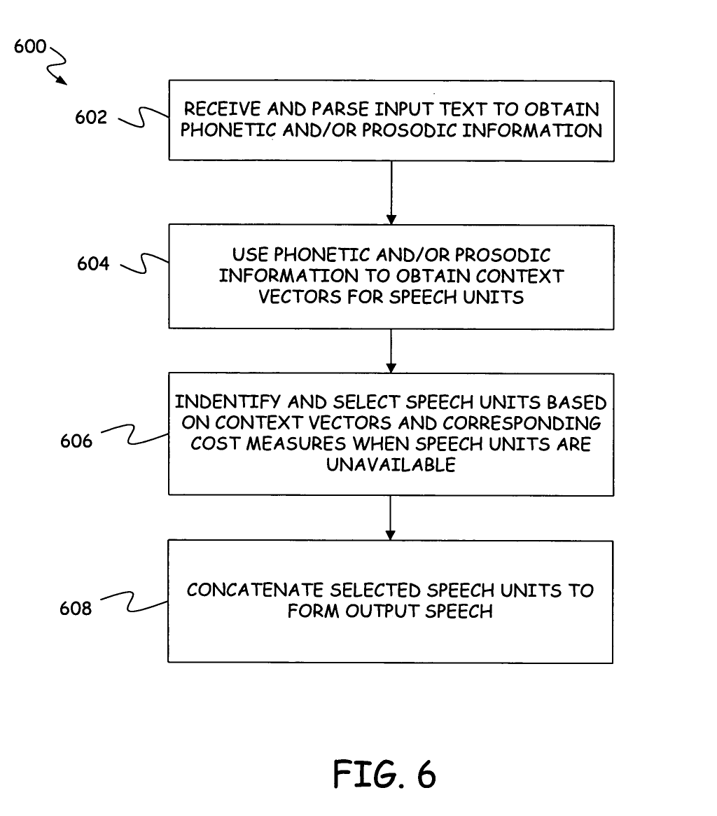

A method 600 for using the cost measures calculated above and stored for example in cost tables 118 of FIG. 1 in speech synthesis is illustrated in FIG. 6 with reference to components illustrated in FIG. 1. At step 602, input text 104 is received and processed by the parser/semantic identifier 108 to parse input text 104 and identify phonetic and/or prosodic information for each speech unit produced by the parse. At step 604, the phonetic and/or prosodic information is then provided to the context vector generator 112, which generates a context vector for each speech unit identified in the parse. The context vectors are provided to a speech unit locator 114, at step 606, which uses the vectors to identify a set of speech units for the sentence. Identification includes using the calculated measures such as stored in cost tables 118 in order to obtain the closest sounding speech unit when a desired speech unit is not available. In some synthesizers, the speech units may be organized in a tree structure where leaf nodes include speech units of similar phonetic and/or prosodic context. In these systems, identification of a suitable speech unit when a desired speech unit is unavailable may be more efficient since a defined sub-set of suitable speech units have been previously classified. Also, speech synthesizer 100 can be operated with single-tier selection, where the speech unit selected is the one with the closest match as defined by the measures of cost tables 118. In a selection process, the speech units selected again are based on the measures of the cost tables; however, with the additional constraint to also consider minimization of cost for the entire sentence or phrase to be synthesized. With the exception of small amounts of smoothing at boundaries between speech units, speech constructor 134 concatenates the speech units to form synthesized speech 102.

Stated another way, FIG. 6A illustrates a method 620 for selecting speech units for a synthesizer. At step 622, a representative measure indicative of a difference between HMM acoustic models of speech units for a word, or other unit of language, is obtained. For example, this can be performed by accessing the cost tables 118. As described above, the representative measure can be indicative of the phonetic and/or prosodic features between the speech units. In addition, in one embodiment, the representative measure can be based on Kullback-Leibler Divergence such as described below or using Monte-Carlo simulation. At step 624, a speech unit to be used by a speech synthesizer is selected based on the representative measure.

Kullback-Leibler Divergence Calculation

Kullback-Leibler Divergence (KLD) is a meaningful statistical measure of the dissimilarity between two probabilistic distributions. If two N-dimensional distributions are respectively assigned to probabilistic or statistical models M and \tilde{M} of x (where untilded and tilded variables are related to the target model and its competing model, respectively), KLD between the two models can be calculated as:

$$D \text{(} M ∥ \tilde{M} \text{)} = \int P ( x \vert M ) log \frac{P ( x \vert M )}{P \text{(} x \vert \tilde{M} \text{)}} d x \qquad ( 3 )$$

However, given two stochastic processes, it is usually cumbersome to calculate their KLD since the random variable sequence can be infinite in length. Although a procedure has been advanced to approximate KLD rate between two HMMs, the KLD rate only measures the similarity between steady-states of two HMMs, while at least with respect to acoustic processing, such as speech processing, the dynamic evolution is of more concern than the steady-states.

KLD between two Gaussian mixtures forms the basis for comparing a pair of acoustic HMM models. In particular, using an unscented transform approach, KLD between two N dimensional Gaussian mixtures

$$b ( o ) = {\sum }_{m = 1}^{M} {w}_{m} 𝒩 ( o ; {μ}_{m} , {Σ}_{m} ) and \tilde{b} ( o ) = {\sum }_{m = 1}^{\tilde{M}} {\tilde{w}}_{m} 𝒩 ( o ; {\tilde{μ}}_{m} , {\tilde{Σ}}_{m} )$$

(where o is the sigma point, w is the kernel weight μ is the mean vector, Σ is the covariance matrix, m is index of M Gaussian kernels) can be approximated by:

$$D \text{(} b ∥ \tilde{b} \text{)} \approx \frac{1}{2 N} {\sum }_{m = 1}^{M} {w}_{m} {\sum }_{k = 1}^{2 N} log \frac{b ( {o}_{m , k} )}{\tilde{b} ( {o}_{m , k} )} \qquad ( 4 )$$

where o_{m,k} is the k^{th} sigma point in the m^{th} Gaussian kernel of M Gaussian kernels of b.

Use of the unscented transform is useful in comparing HMM models.

As is known, HMMs for phones can have unequal number of states. In the following, a synchronous state matching method is used to first measure the KLD between two equal-length HMMs, then it is generalized via a dynamic programming algorithm for HMMs of different numbers of states. It should be noted, all the HMMs are considered to have a no skipping, left-to-right topology.

In left-to-right HMMs, dummy end states are only used to indicate the end of the observation, so it is reasonable to endow both of them an identical distribution, as a result, D(b_{J}∥\tilde{b}_{J})=0. Based on the following decomposition of π (vector of initial probabilities), A (state transition matrix) and d (_distance between two states):

$$π = ( \frac{{π}^{′}}{0} ) , A = ( \begin{matrix}{A}^{′} & * \\ 0 & 1\end{matrix} ) , d = ( \frac{{d}^{′}}{0} )$$

the following relationship is obtained:

$${π}^{T} {\sum }_{t = 1}^{τ} {A}^{t - 1} d = {π}^{′ T} {\sum }_{t = 1}^{τ} {A}^{′ t - 1} {d}^{′}$$

where T represent transpose, t is time index and τ is the length of observation in terms of time.

By substituting,

$$π = ( \begin{matrix}1 \\ 0 \\ 0 \\ ⋮ \\ 0 \\ 0\end{matrix} ) A = ( \begin{matrix}{a}_{11} & {a}_{12} & 0 & ⋯ & 0 & 0 \\ 0 & {a}_{22} & {a}_{23} & ⋯ & 0 & 0 \\ ⋮ & ⋮ & ⋰ & ⋰ & ⋮ & ⋮ \\ 0 & 0 & 0 & ⋰ & {a}_{J - 2 , J - 1} & 0 \\ 0 & 0 & 0 & ⋯ & {a}_{J - 1 , J - 1} & {a}_{J - 1 , J} \\ 0 & 0 & 0 & ⋯ & 0 & 1\end{matrix} )$$

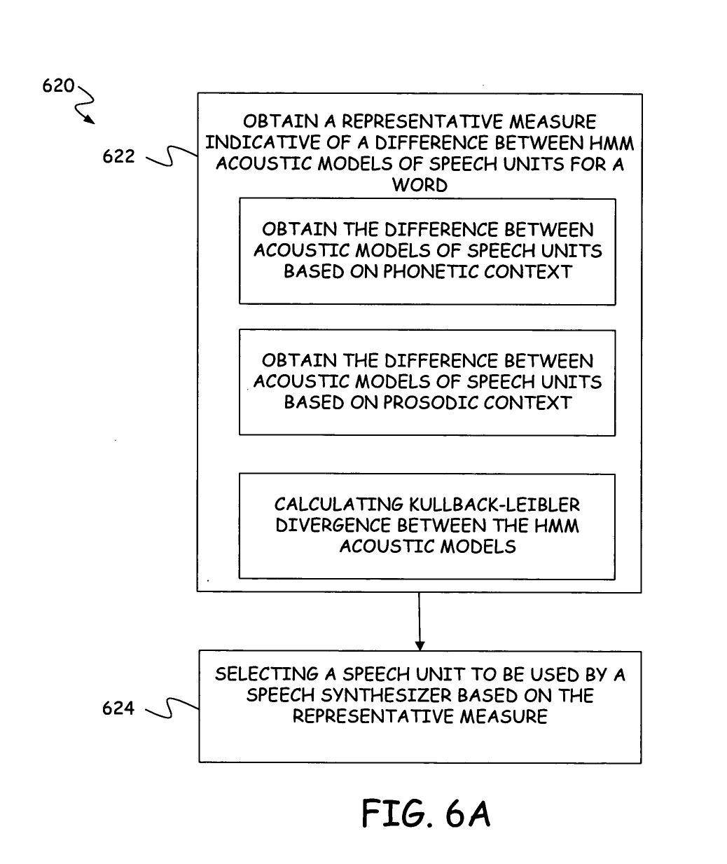

an approximation of KLD for symmetric (equal length) HMMs can be represented as:

$${D}_{S} \text{(} ℋ ∥ \tilde{ℋ} \text{)} \leq {\sum }_{i = 1}^{J - 1} {Δ}_{i , i}$$

where Δ_{i,j} represents the symmetric KLD between the i^{th} state in the first HMM and the j^{th} state in the second HMM, and can be represented as:

$${Δ}_{i , j} = {\underbrace{[ D ( {b}_{i} ∥ {\tilde{b}}_{j} ) + log \frac{{a}_{ii}}{{\tilde{a}}_{jj}} ] {l}_{i}}}_{{{Δ}^{->}}_{i , j}} + {\underbrace{[ D ( {\tilde{b}}_{j} ∥ {b}_{i} ) + log \frac{{\tilde{a}}_{jj}}{{a}_{ii}} ] {\tilde{l}}_{i}}}_{{\overleftarrow{Δ}}_{i , j}}$$

where lᵢ=(1/1−aᵢᵢ) is the average duration of the i^{th} state and the terms Δ̅_{i,j} and Δ̅_{i,j} represents the two asymmetric state KLDs respectively, which can be approximated based on equation (4) above. As illustrated in FIG. 3 and referring to FIG. 7, a method 700 for calculating the total KLD for comparing two HMMs (based on an unscented transform) is to calculate a KLD for each pair of states, state by state, at step 702, and sum the individual state KLD calculations to obtain the total KLD at step 704.

Having described calculation of KLD for equal length HMMs, a more flexible KLD method using Dynamic Programming (DP) will be described to deal with two unequal-length left-to-right HMMs, where J and \tilde{J} will be used to denote the state numbers of the first and second HMM, respectively.

In a state-synchronized method as described above and illustrated in FIG. 7, KLD is calculated state by state for each corresponding pair. In order to relax the constraint, a simple case, where a 2-state and a 1-state HMMs with the following transition matrices

$$A = ( \begin{matrix}{a}_{11} & 1 - {a}_{11} & 0 \\ 0 & {a}_{22} & 1 - {a}_{22} \\ 0 & 0 & 1\end{matrix} ) , \tilde{A} = ( \begin{matrix}{\tilde{a}}_{11} & 1 - {\tilde{a}}_{11} \\ 0 & 1\end{matrix} )$$

will first be compared.

It can be shown that that the upper bound can be represented as

D_{S}(H∥\tilde{H})≦Δ_{1,1}+Δ_{2,1}+φ(ã₁₁,a₁₁,a₂₂) (5)

where φ(ã₁₁,a₁₁,a₂₂) is a penalty term following the function φ(z,x,y)=(1−z)/(1−x)+(1−z)/(1−y). Although it is to be appreciated that any suitable penalty may be used, including a zero penalty.

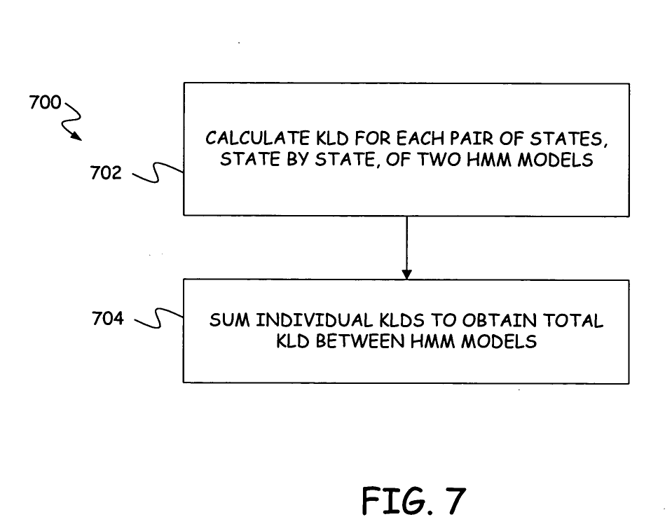

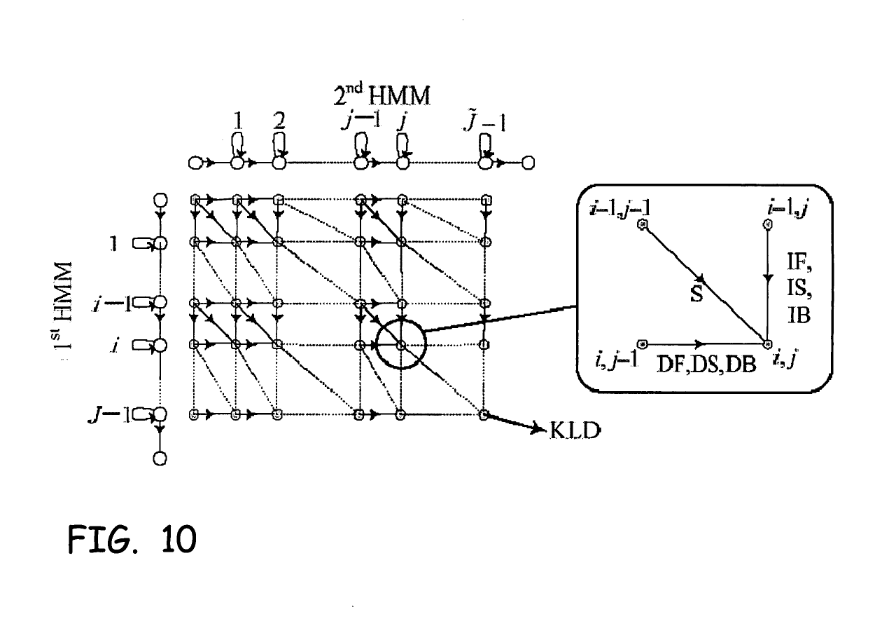

Referring to FIG. 11, KLD can be calculated between a 2-state HMM and a 1-state HMM as follows: First, convert 1102 the 1-state HMM to a 2-state HMM one by duplicating its state and add a penalty of φ(a₁₁,a₁₁,a₂₂). Then, calculate 1108 and sum 1110 up the KLD state pair by state pair using the state-synchronized method described above. As illustrated in FIG. 8, a schematic diagram of state duplication (copy) 802 with a penalty 804 is one form of technique that can be used to create an equal number of states between the HMMs. As illustrated in FIG. 8, the HMM 806 has added state 802 to create two states paired equally with the two states 810 of HMM 808.

It has been discovered that the calculation of KLD between two HMMs can be treated in a manner similar to a generalized string matching process, where state and HMM are counterparts of character and string, respectively. Although various algorithms as is known can be used as is done in string matching, in one embodiment, the basic DP algorithm (Seller, P., “The Theory and Computation of Evolutionary Distances: Pattern Recognition”, Journal of Algorithms. 1: 359-373, 1980) based on edit distance (Levenshtein, V., “Binary Codes Capable of Correcting Spurious Insertions and Deletions of Ones”, Problems of information Transmission, 1:8-17, 1965) can be used. The algorithm is flexible to adaptation in the present application.

In string matching, three kinds of errors are considered: insertion, deletion and substitution. Edit distances caused by all these operations are identical. In KLD calculation, they should be redefined to measure the divergence reasonably. Based on Equation (5) and the atom operation of state copy, generalized edit distances can be defined as:

Generalized substitution distance: If the i^{th} state in the first HMM and the j^{th} state in the second HMM are compared, the substitution distance should be δ_{S}(i,j)=Δ_{i,j}.

Generalized insertion distance: During DP, if the i^{th} state in the first HMM is treated as a state insertion, three reasonable choices for its competitor in the 2^{nd} HMM can be considered:

(a) Copy the j^{th} state in the second HMM forward as a competitor, then the insertion distance is

δ_{IF}(i,j)=Δ_{i-1,j}+Δ_{i,j}+φ(ãⱼⱼ,a_{i-1,i-1},aᵢᵢ)−Δ_{i,j}=Δ_{i,j}+φ(ãⱼⱼ,a_{i-1,i-1},aᵢᵢ)

(b) Copy the j+1^{th} state in the second HMM backward as a competitor, then the insertion distance is

δ_{IB}(i,j)=Δ_{i,j+1}+Δ_{i+1,j+1}+φ(ã_{j+1,j+1},aᵢᵢ,a_{i+1,j+1})−Δ_{i+1,j+1}=Δ_{i,j+1}+φ(ã_{j+1,j+1},aᵢᵢ,a_{i+1,i+1})

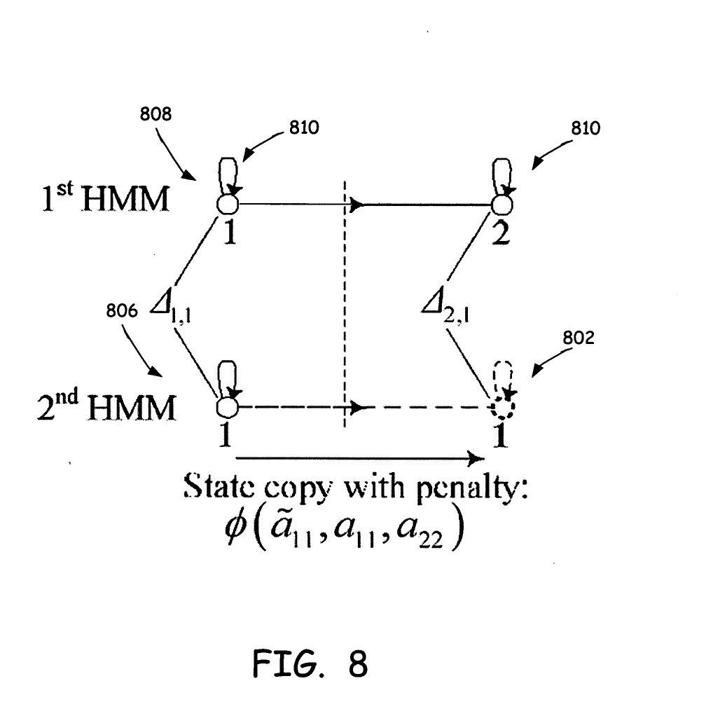

(c) Incorporate a “non-skippable” short pause (sp) state in the second HMM as a competitor with the i^{th} states in the first HMM, and the insertion distance is defined as δ_{IS}(i,j)=Δ_{i,sp}. Here the insertion of the sp state is not penalized because it is treated as a modified pronunciation style to have a brief stop in some legal position. It should be noted that the short pause insertion is not always reasonable, for example, it may not appear at any intra-syllable positions. FIG. 9 illustrates each of the foregoing possibilities with the first HMM 900 being compared to a second HMM 902 that may have a state 922 copied forward to state 924, a state 926 copied backward to state 928, or a short pause 930 inserted between states 932 and 934.

Generalized deletion distance: A deletion in the first HMM can be treated as an insertion in the second HMM. So the competitor choices and the corresponding distance are symmetric to those in state insertion:

δ_{DF}(i,j)=Δ_{i,j}+φ(aᵢᵢ,ã_{j-1,j-1},aⱼⱼ),

δ_{DB}(i,j)=Δ_{i+1,j}+φ(a_{i+1,i+1},ãⱼⱼ,ã_{j+1,j+1}),

δ_{DS}(i,j)=Δ_{sp,j}.

To deal with the case of HMM boundaries, the following are defined:

Δ_{i,j}=∞,(i ∉ [1,J−1] or j ∉ [1,J−1]),

φ(a,ã_{j-1,j-1},ãⱼⱼ)=∞(j ∉ [2,\tilde{J}−1]) and

φ(ã,a_{i-1,i-1},aⱼⱼ)=∞(i ∉ [2,J−1])

In view of the foregoing, a general DP algorithm for calculating KLD between two HMMs regardless of whether they are equal in length can be described. This method is illustrated in FIG. 11 at 1100. At step 1102, if the two HMMs to be compared are of different length, one or both are modified to equalize the number of states. In one embodiment, as indicated at step 1104, one or more modifications can be performed at each state from a set of operations comprising Ω={Substitution(S), Forward Insertion (IF), Short pause Insertion (IS), Backward Insertion (IB), Forward Deletion (DF), Short pause Deletion (DS), Backward Deletion (DB)}, where each of the operations of Insertion, Deletion and Substitution have a corresponding penalty for being implemented. At step 1106, the operation having the lowest penalty is retained. Steps 1104 and 1106 are repeated until the HMMs are of the same length.

If desired, during DP at step 1104, a J×\tilde{J} cost matrix C can be used to save information. Each element C_{i,j} is an array of {C_{i,j,OP}},OP∈Ω, where C_{i,j,OP} means the partially best result when the two HMMs reach their i^{th} and j^{th} states respectively, and the current operation is OP.

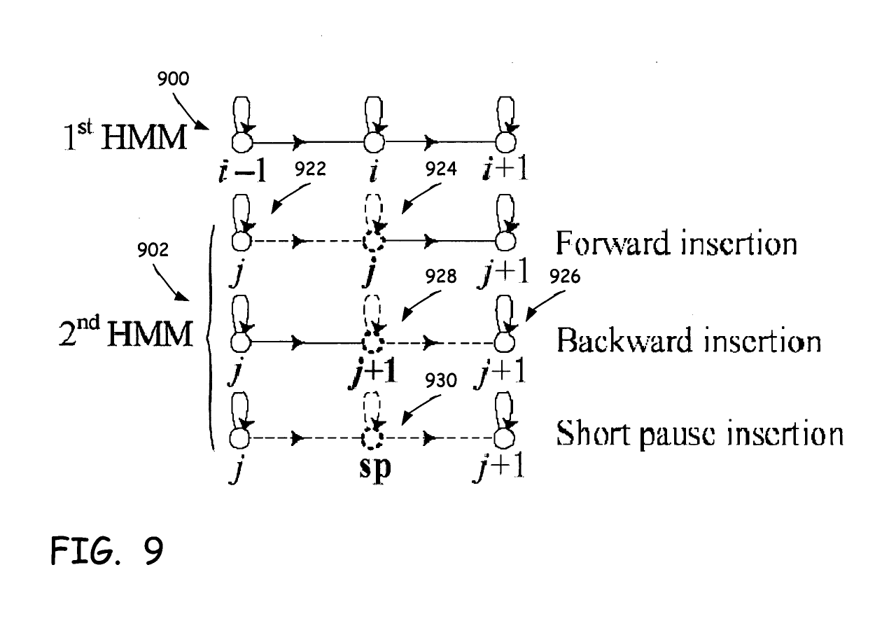

FIG. 10 is a schematic diagram of the DP procedure as applied to two left-to-right HMMs, HMM 1002, which as “i” states, and HMM 1004, which has “j” states. FIG. 10 illustrates all of the basic operations, where the DP procedure begins at node 1006 with the total KLD being obtained having reached node 1008. In particular, transitions from various states include Substitution(S) indicated by arrow 1010; Forward Insertion (IF), Short pause Insertion (IS) and Backward Insertion (IB) all indicated by arrow 1012; and Forward Deletion (DF), Short pause Deletion (DS) and Backward Deletion (DB) all indicated by arrow 1014.

Saving all or some of the operation related variables may be useful since the current operation depends on the previous one. A “legal” operation matrices listed in table 1 below may be used to direct the DP procedure. The left table is used when sp is incorporated, and the right one is used when it is forbidden.

TABLE 1
Legality of operation pairs

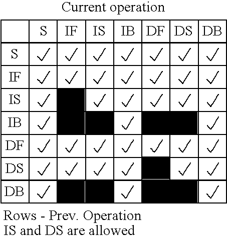

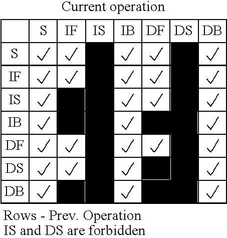

For all OP∈Ω, elements of cost matrix C can be filled iteratively as follows:

$$\{ \begin{matrix} {C}_{0 , 0 , OP} = 0 \\ {C}_{i , 0 , OP} = {min}_{{OP}_{1} ∈ Ω , ( {OP}_{1} , OP ) is legal} {C}_{i - 1 , 0 , {OP}_{1}} + {δ}_{OP} ( i , 0 ) , ( 0 < i \leq J - 1 ) \\ {C}_{0 , j , OP} = {min}_{{OP}_{1} ∈ Ω , ( {OP}_{1} , OP ) is legal} {C}_{0 , j - 1 , {OP}_{1}} + {δ}_{OP} ( 0 , j ) , ( 0 < j \leq \tilde{J} - 1 ) \\ {C}_{i , j , OP} = {min}_{{OP}_{1} ∈ Ω , ( {OP}_{1} , OP ) is legal} {C}_{From ( i , j , OP ) , {OP}_{1}} + {δ}_{OP} ( i , j ) , ( 0 < i \leq J - 1 , 0 < j \leq \tilde{J} - 1 )\end{matrix}$$

where From(i,j,OP) is the previous position given the current position (i,j) and current operation OP, from FIG. 10 it is observed:

$$From ( i , j , OP ) = \{ \begin{matrix} ( i - 1 , j - 1 ) if OP = S \\ ( i - 1 , j ) if OP ∈ \{ IF , IS , IB \} \\ ( i , j - 1 ) if OP ∈ \{ DF , DS , DB \}\end{matrix}$$

At the end of the dynamic programming, the KLD approximation can be obtained:

$${D}_{S} \text{(} ℋ ∥ \tilde{ℋ} \text{)} \approx {min}_{OP ∈ Ω} {C}_{J - 1 , \tilde{J} - 1 , OP}$$

In a further embodiment, another J×\tilde{J} matrix B can be used as a counterpart of C at step 1106 to save the best previous operations during DP. Based on the matrix, the best state matching path can be extracted by back-tracing from the end position (J−1,\tilde{J}−1).

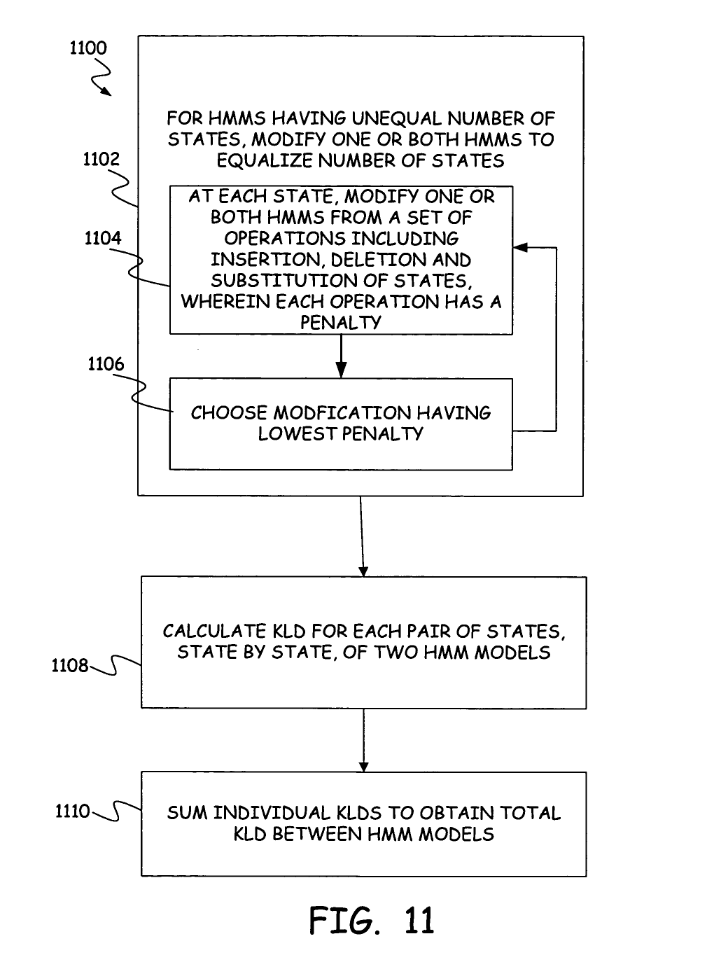

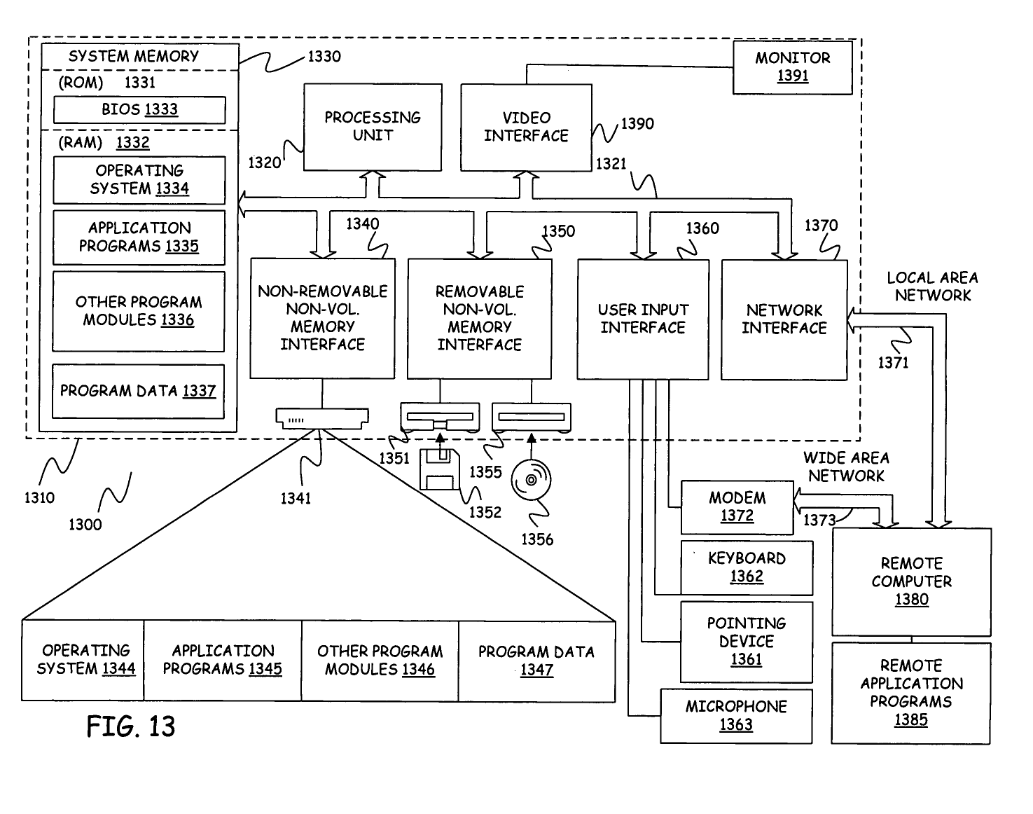

FIG. 12 shows a demonstration of DP based state matching. In the case of FIG. 12, KLD between the HMMs of syllables “act” (/ae k t/) 1202 and “tack” (/t ae k/) 1204 are calculated. The two HMMs are equal in length with only slight difference: the tail phoneme in the first syllable is moved to head in the second one. From the figure, it can be seen that the two HMMs are well aligned according to their content, and a quite reasonable KLD value of 788.1 is obtained, while the state-synchronized result is 2529.5. In the demonstration of FIG. 14, KLD between the HMMs of syllables “sting” (/s t ih ng/) 1402 and “string” (/s t r ih ng/) 1404, where a phoneme r is inserted in the latter, are calculated. Because the lengths are unequal now, state synchronized algorithm is helpless, but DP algorithm is also able to match them with outputting a reasonable KLD value of 688.9.

In the state-synchronized algorithm, there is a strong assumption that the two observation sequences jump from one state to the next one synchronously. For two equal-length HMMs, the algorithm is quite effective and efficient. Considering the calculation of A as a basic operation, its computational complexity is O(J). This algorithm lays a fundamental basis for the DP algorithm.

In the DP algorithm, the assumption that the two observation sequences jump from one state to the next one synchronously is relaxed. After penalization, the two expanded state sequences corresponding to the best DP path are equal in length, so the state-synchronized algorithm (FIG. 7) can also be used in such case as illustrated by steps 1108 and 1110 (FIG. 11), which correspond substantially to steps 702 and 704, respectively. However, this algorithm is more effective in dealing with both equal-length HMMs and unequal-length HMMs, but it is less efficient with a computational complexity of O(J×\tilde{J}).

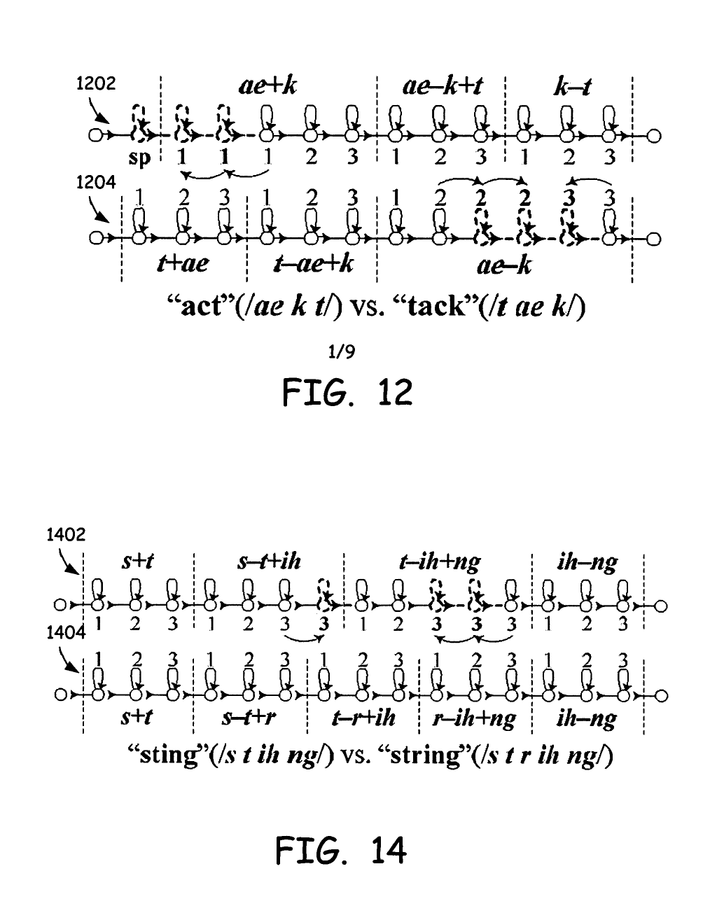

FIG. 13 illustrates an example of a suitable computing system environment 1300 on which the concepts herein described may be implemented. Nevertheless, the computing system environment 1300 is again only one example of a suitable computing environment for each of these computers and is not intended to suggest any limitation as to the scope of use or functionality of the description below. Neither should the computing environment 1300 be interpreted as having any dependency or requirement relating to any one or combination of components illustrated in the exemplary operating environment 1300.

In addition to the examples herein provided, other well known computing systems, environments, and/or configurations may be suitable for use with concepts herein described. Such systems include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The concepts herein described may be embodied in the general context of computer-executable instructions, such as program modules, being executed by a computer. Generally, program modules include routines, programs, objects, components, data structures, etc. that perform particular tasks or implement particular abstract data types. Those skilled in the art can implement the description and/or figures herein as computer-executable instructions, which can be embodied on any form of computer readable media discussed below.

The concepts herein described may also be practiced in distributed computing environments where tasks are performed by remote processing devices that are linked through a communications network. In a distributed computing environment, program modules may be located in both locale and remote computer storage media including memory storage devices.

With reference to FIG. 13, an exemplary system includes a general purpose computing device in the form of a computer 1310. Components of computer 1310 may include, but are not limited to, a processing unit 1320, a system memory 1330, and a system bus 1321 that couples various system components including the system memory to the processing unit 1320. The system bus 1321 may be any of several types of bus structures including a memory bus or memory controller, a peripheral bus, and a locale bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

Computer 1310 typically includes a variety of computer readable media. Computer readable media can be any available media that can be accessed by computer 1310 and includes both volatile and nonvolatile media, removable and non-removable media. By way of example, and not limitation, computer readable media may comprise computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1300.

The system memory 1330 includes computer storage media in the form of volatile and/or nonvolatile memory such as read only memory (ROM) 1331 and random access memory (RAM) 1332. A basic input/output system 1333 (BIOS), containing the basic routines that help to transfer information between elements within computer 1310, such as during start-up, is typically stored in ROM 1331. RAM 1332 typically contains data and/or program modules that are immediately accessible to and/or presently being operated on by processing unit 1320. By way of example, and not limitation,

FIG. 13 illustrates operating system 1334, application programs 1335, other program modules 1336, and program data 1337. Herein, the application programs 1335, program modules 1336 and program data 1337 implement one or more of the concepts described above.

The computer 1310 may also include other removable/non-removable volatile/nonvolatile computer storage media. By way of example only, FIG. 13 illustrates a hard disk drive 1341 that reads from or writes to non-removable, nonvolatile magnetic media, a magnetic disk drive 1351 that reads from or writes to a removable, nonvolatile magnetic disk 1352, and an optical disk drive 1355 that reads from or writes to a removable, nonvolatile optical disk 1356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1341 is typically connected to the system bus 1321 through a non-removable memory interface such as interface 1340, and magnetic disk drive 1351 and optical disk drive 1355 are typically connected to the system bus 1321 by a removable memory interface, such as interface 1350.

The drives and their associated computer storage media discussed above and illustrated in FIG. 13, provide storage of computer readable instructions, data structures, program modules and other data for the computer 1310. In FIG. 13, for example, hard disk drive 1341 is illustrated as storing operating system 1344, application programs 1345, other program modules 1346, and program data 1347. Note that these components can either be the same as or different from operating system 1334, application programs 1335, other program modules 1336, and program data 1337. Operating system 1344, application programs 1345, other program modules 1346, and program data 1347 are given different numbers here to illustrate that, at a minimum, they are different copies.

A user may enter commands and information into the computer 1310 through input devices such as a keyboard 1362, a microphone 1363, and a pointing device 1361, such as a mouse, trackball or touch pad. These and other input devices are often connected to the processing unit 1320 through a user input interface 1360 that is coupled to the system bus, but may be connected by other interface and bus structures, such as a parallel port or a universal serial bus (USB). A monitor 1391 or other type of display device is also connected to the system bus 1321 via an interface, such as a video interface 1390.

The computer 1310 may operate in a networked environment using logical connections to one or more remote computers, such as a remote computer 1380. The remote computer 1380 may be a personal computer, a hand-held device, a server, a router, a network PC, a peer device or other common network node, and typically includes many or all of the elements described above relative to the computer 1310. The logical connections depicted in FIG. 13 include a locale area network (LAN) 1371 and a wide area network (WAN) 1373, but may also include other networks. Such networking environments are commonplace in offices, enterprise-wide computer networks, intranets and the Internet.

When used in a LAN networking environment, the computer 1310 is connected to the LAN 1371 through a network interface or adapter 1370. When used in a WAN networking environment, the computer 1310 typically includes a modem 1372 or other means for establishing communications over the WAN 1373, such as the Internet. The modem 1372, which may be internal or external, may be connected to the system bus 1321 via the user-input interface 1360, or other appropriate mechanism. In a networked environment, program modules depicted relative to the computer 1310, or portions thereof, may be stored in the remote memory storage device. By way of example, and not limitation, FIG. 13 illustrates remote application programs 1385 as residing on remote computer 1380. It will be appreciated that the network connections shown are exemplary and other means of establishing a communications link between the computers may be used.

It should be noted that the concepts herein described can be carried out on a computer system such as that described with respect to FIG. 13. However, other suitable systems include a server, a computer devoted to message handling, or on a distributed system in which different portions of the concepts are carried out on different parts of the distributed computing system.

Although the subject matter has been described in language specific to structural features and/or methodological acts, it is to be understood that the subject matter defined in the appended claims is not limited to the specific features or acts described above as has been held by the courts. Rather, the specific features and acts described above are disclosed as example forms of implementing the claims.

What is claimed is:

1. A method for selecting speech units in a concatenative speech synthesizer comprising:
obtaining a representative measure indicative of a difference between HMM acoustic models of speech units
selecting a speech unit to be used by a speech synthesizer based on the representative measure.

2. The method of claim 1 wherein obtaining the representative measure comprises obtaining the representative measure indicative of the difference between acoustic models of speech units in different phonetic context.

3. The method of claim 2 wherein the phonetic context is based on a preceding speech unit.

4. The method of claim 2 wherein the phonetic context is based on a succeeding speech unit.

5. The method of claim 1 wherein obtaining the representative measure comprises obtaining the representative measure indicative of the difference between acoustic models of speech units in different prosodic context.

6. The method of claim 5 wherein the prosodic context is based on position of the speech unit in a word.

7. The method of claim 5 wherein the prosodic context is based on position of the speech unit in a syllable of a word.

8. The method of claim 5 wherein the prosodic context is based on accent status of the speech unit in a word.

9. The method of claim 5 wherein the prosodic context is based on position of a word in a phrase.

10. The method of claim 5 wherein the prosodic context is based on emphasis status of a word in a phrase.

11. The method of claim 1 wherein obtaining the representative measure indicative of the difference between HMM acoustic models of speech units is based on calculating Kullback-Leibler Divergence between the HMM acoustic models.

12. A method of synthesizing speech comprising:
receiving input text and parsing the input text to obtain phonetic one or both prosodic information;
generating context vectors based on the phonetic one or both prosodic information;
generating cost measures corresponding to the context vectors, the cost measures being based on a comparison of acoustic HMM models of speech units;
selecting one or more speech units based on the context vectors and corresponding cost measures when speech units having desired context vectors are not available;
concatenating the one or more selected speech units to form a synthesized speech output representing the input text.

13. The method of claim 12 wherein the cost measures are indicative of a comparison based on phonetic features.

14. The method of claim 13 wherein the cost measures are indicative of a comparison based on prosodic features.

15. The method of claim 12 wherein the cost measures are indicative of a comparison based on prosodic features.

16. The method of claim 12 wherein the cost measures are speech unit dependent.

17. A speech synthesizer comprising:
a store of speech units indicative of at least one of different phonetic and different prosodic contexts;
a set of cost measures associated with the speech units of the store of speech units, the cost measures being indicative of a comparison of acoustic HMM models of speech units of said at least one of different phonetic and different prosodic contexts; and
a speech unit locator configured to select speech units to be used for forming synthesized speech based on accessing the set of cost measures when desired speech units of at least one of phonetic and prosodic contexts are not available in the store of speech units.

18. The synthesizer of claim 17 wherein each cost measure of the set of cost measures comprise a Kullback-Leibler Divergence between the HMM acoustic models.

19. The synthesizer of claim 17 wherein the set of cost measures are speech unit dependent.

20. The synthesizer of claim 18 wherein a sub-set of cost measures pertain to a plurality of speech units.
